(19) United States
(12) Patent Application Publication
(10) Pub. No.: US 2013/0159228 A1
(43) Pub. Date: Jun. 20, 2013

(54) DYNAMIC USER EXPERIENCE ADAPTATION AND SERVICES PROVISIONING

(71) Applicants: Henricus Johannes Maria Meijer, Mercer Island, WA (US); Roger Barga, Bellevue, WA (US); Carl Carter-Schwendler, Redmond, WA (US); Alexander Sasha Stojanovic, Los Gatos, CA (US)

(72) Inventors: Henricus Johannes Maria Meijer, Mercer Island, WA (US); Roger Barga, Bellevue, WA (US); Carl Carter-Schwendler, Redmond, WA (US); Alexander Sasha Stojanovic, Los Gatos, CA (US)

(73) Assignee: MICROSOFT CORPORATION, Redmond, WA (US)

(21) Appl. No.: 13/329,116

(22) Filed: Dec. 16, 2011

(51) Int. Cl. G06F 15/18

(52) U.S. Cl. 706/14

(57) ABSTRACT

The subject disclosure generally relates to dynamic user experience adaptation and services provisioning. A user experience component can provide a user experience (UX) to a user. The UX can include, but is not limited to, an operating system, an application (e.g., word processor, electronic mail, computer aided drafting, video game, etc.), a user interface, and so forth. A monitoring component can monitor feedback generated in association with interaction with the user experience by the user. An update component can analyze the feedback, and update a user model associated with the user based at least in part on the analysis, and an adaptation component can modify the user experience based at least in part the user model.

### TECHNICAL FIELD

The subject disclosure relates to user experience design, and more particularly to dynamically adapting user experience and provisioning services based on feedback.

### BACKGROUND

In the domain of user experience design, some of the most challenging aspects relate to anticipating difficulties that will be encountered by a set of users for a given experience. Designing a user experience that accounts for difficulties encountered by different levels of users has been an exceptionally difficult task. User experience designers often attempt to create a one-size fits all design that requires the users to customize the experience based on their skill set. Part of the difficulty lies in the various ability and experience levels that a target set of users may possess. Some users may not have sufficient experience or expertise to customize the experience to its full potential for their skill set. While more advanced users may be frustrated by a simplified design.

As personal computing devices become more ubiquitous, a large segment of consumers are growing to expect more personalized and intuitive user experiences. In addition, technology savvy consumers may place a premium on complicated or high level features, yet still desire a personalized user experience. Furthermore, when large numbers of users encounter similar difficulties with a user experience it is often viewed as a design error or failure. Designers often have to apply a one-size fits all solution to wide ranging user difficulties, such as an update.

The above-described deficiencies of today's techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, systems and methods are provided for dynamic user experience adaptation and services provisioning. In accordance therewith, a system is provided that includes a monitoring component configured to monitor feedback generated in association with interaction with a user experience by a user, an update component configured to analyze the feedback, and update a user model associated with the user based at least in part on the analysis, and an adaptation component configured to modify the user experience based at least in part the user model.

In another embodiment, a method is provided that includes receiving feedback generated during interaction with a user experience by a user, interpreting the feedback based at least in part on a set of attributes included in a user model for the user experience, updating at least one of the attributes in the set of attributes in a user model associated with the user based at least in part on the interpretation, and adapting the user experience for the user based at least in part the user model.

In yet another embodiment, a computer-readable storage medium is provided that includes providing a user experience, monitoring interaction with the user experience by a user, obtaining feedback associated with the interaction including at least one of: usage feedback, query feedback, or a sensed characteristic of the user, updating a user model associated with the user based at least in part on the feedback; and adapting the user experience for the user, based at least in part on the user model, including at least one of: modifying at least one feature or function of the user experience, or providing at least one of: an advertisement, an aid, a marketplace, or remote assistance.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates a block diagram of an exemplary non-limiting system that dynamically adapts a user experience and provisions services;

FIG. 2 illustrates a block diagram of an exemplary non-limiting system that dynamically adapts a user experience and provisions services;

FIG. 3 illustrates a block diagram of an exemplary non-limiting system that dynamically adapts a user experience and provisions services;

FIG. 4 illustrates a block diagram of an exemplary non-limiting system that dynamically adapts a user experience and provisions services;

FIG. 5 illustrates a block diagram of an exemplary non-limiting system that dynamically adapts a user experience and provisions services;

FIG. 6 illustrates a block diagram of an exemplary non-limiting system that provide additional features or aspects in connection with dynamic user experience adaptation and services provisioning;

FIG. 7-9 are exemplary non-limiting flow diagrams for dynamic user experience adaptation and services provisioning;

FIG. 10 is a block diagram representing exemplary non-limiting networked environments in which various embodiments described herein can be implemented; and

FIG. 11 is a block diagram representing an exemplary non-limiting computing system or operating environment in which one or more aspects of various embodiments described herein can be implemented.

### DETAILED DESCRIPTION

### Overview

By way of an introduction, the subject matter disclosed herein relates to various embodiments relating to dynamic user experience adaptation and services provisioning. In particular, the subject matter can provide a mechanism for receiving feedback generated during interaction with a user experience by a user, interpreting the feedback based at least in part on a set of attributes included in a user model for the user experience, updating at least one of the attributes in the set of attributes in a user model associated with the user based at least in part on the interpretation, and adapting the user experience for the user based at least in part the user model.

In addition, aspects of the disclosed subject matter can predict an action intended by the user, a difficulty of the user, or an error, and provide a set services based in part on the prediction. Additionally, feedback generated during interaction with a user experience can be interpreted to determine or infer an emotional state of the user, and the services can be provided based in part on the emotional state.

### Dynamic User Experience Adaptation and Assistance

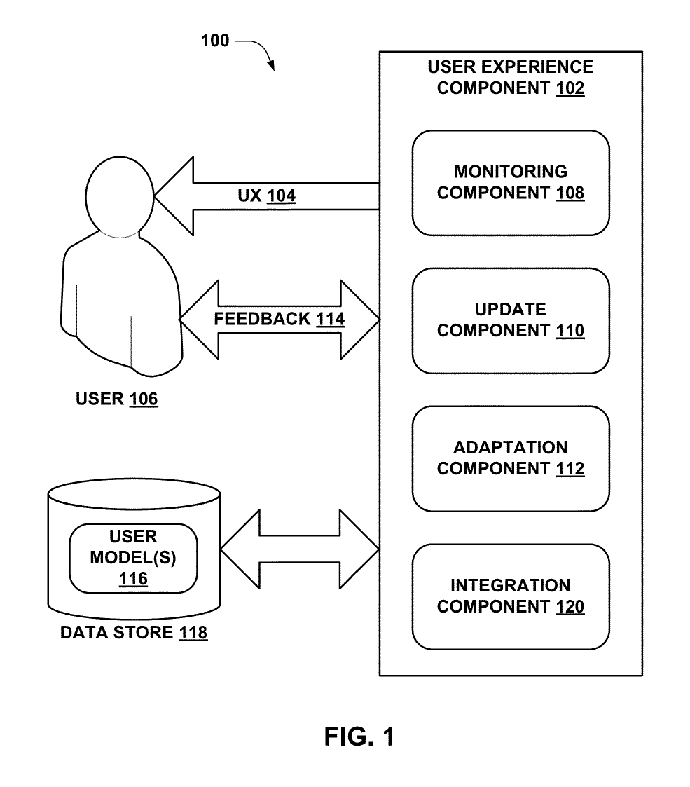

Referring now to the drawings, with reference initially to FIG. 1, system 100 that dynamically adapts a user experience and provisions services is shown in accordance with various aspects described herein. Generally, system 100 can include a user experience component 102 that, as with all components described herein can be stored in a computer readable storage medium. The user experience component 102 is configured to generate, supply, or otherwise provide a user experience (UX) 104 to a user 106. The UX 104 can include, but is not limited to, an operating system, an application (e.g., word processor, electronic mail, computer aided drafting, video game, etc.), a user interface, and so forth. The UX 104 can be executed via virtually any computing device including, but not limited to, a smart phone, a cell phone, a personal digital assistant (PDA), a tablet, a laptop, a desktop, a portable music player, a video game system, an electronic reader (e-reader), a global positing system (GPS), a television, and so forth. The user experience component 102 includes a monitoring component 108, an update component 110, and an adaptation component 112.

The monitoring component 108 is configured to obtain, acquire, or otherwise receive feedback 114 generated during, or in association with, the user's 106 interaction with the UX 104. The feedback 114 can be express or implied. For example, the feedback 114 can include a response to a feedback question (e.g., challenge-answer feedback, query feedback, etc.) provided to the user 106. As an additional example, the feedback 114 can be implied by the monitoring component 108 based on the user's 106 interaction (e.g., control, usage, inputs, etc.) with the UX 104, a sensed characteristic of the user 106 (e.g., heart rate, temperature, stress, etc.) during interaction with the UX 104, or an emotional response (e.g., pleased, frustrated, etc.) to the UX 104 or an event associated with the UX 104.

The update component 110 is configured to analyze or interpret the feedback 114, and adjust, modify, or otherwise update a user model 116 associated with the user 106 based in part on the analysis or interpretation. For example, the monitoring component 108 can monitor the user's 106 interaction with an application (e.g., UX 104), and determine that the user 106 predominately (e.g., above a predetermined threshold) employs a set of keyboard shortcuts to achieve an output or result in the application. The update component 110 can interpret the usage of keyboard shortcuts as a level of familiarity with the application's menu options, and update a corresponding attribute in the user model 116 to reflect the level familiarity with the menu options. The user model 116 can contain a set of attributes that indicate the user's 106 ability, comfort, familiarity, etc. with regard to various features or functions of the UX 104. For example, a first subset of the attributes can indicate a user's ability regarding a first feature or function of the UX 104, and a second subset of the attributes can indicate a user's ability regarding a second feature or function of the UX 104.

The update component 110 can update the user model 116 by assigning a grade, score, classification, etc. to one or more of the attributes in the user model 116. Additionally or alternatively, the update component 110 can update the user model 116 by incrementing or decrementing a value or score for one or more attributes in the user model. It is to be appreciated that although the user model 116 is illustrated as being maintained in a data store 118 associated with the user experience component 102, such implementation is not so limited. For instance, the user model 116 can be included in the user experience component 102, or maintained in a disparate location and accessed via a network connection.

The adaptation component 112 is configured to modify, adjust, or otherwise adapt the UX 104 based on the user model 116. The adaptation component 112 can add (e.g., display, expose, etc.) or remove (e.g., hide, suppress, etc.) features based on the user model 116. For example, when the user model 116 indicates that the user 106 predominately uses keyboard shortcuts for a first feature, the adaptation component 112 can hide a toolbar, or set of menus, in a user interface associated with the first feature. In addition, the adaptation component 112 can provide a set of services for the UX 104 based on the user model 116. For example, if the user model 116 indicates that the user 106 is unfamiliar or uncomfortable with a set of features for the UX 104, the adaptation can provide tutorials, remote assistance, or suggestions regarding the set of features.

Additionally, the user experience component 102 can include an integration component 120. The integration component 120 includes any suitable and/or useful adapters, connectors, channels, communication paths, etc. to integrate the user experience component 102 into virtually any operating and/or database system(s). Moreover, the integration component 120 can provide various adapters, connectors, channels, communication paths, etc., that provide for interaction with the user experience component 102. It is to be appreciated that although the integration component 120 is illustrated as incorporated into the user experience component 102, such implementation is not so limited. For instance, the integration component 120 can be a stand-alone component to receive or transmit data in relation to the user experience component 102.

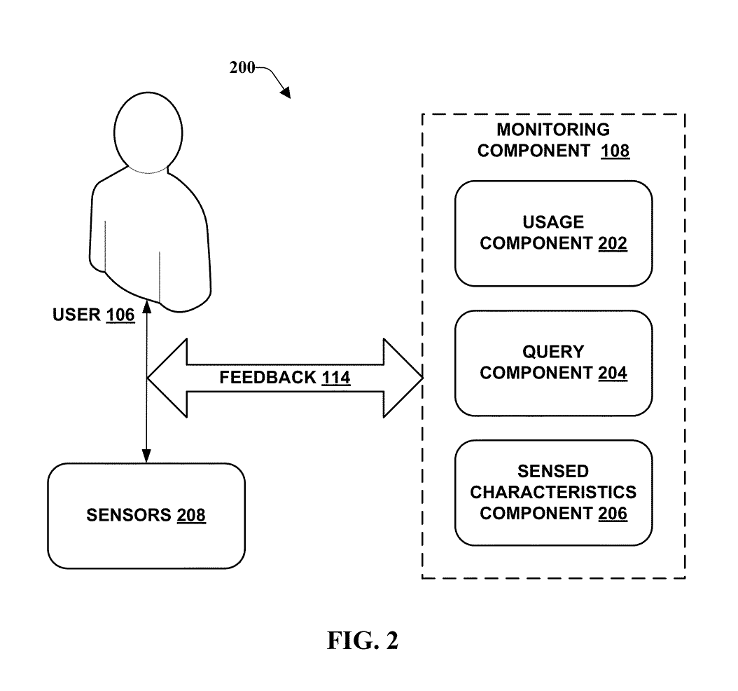

Turning to FIG. 2, illustrated is an example monitoring component 108 in accordance with various aspects described herein. As discussed, the monitoring component 108 is configured to receive implicit or explicit feedback 114 generated during, or in association with, the user's 106 interaction with a UX 104. The monitoring component 108 in FIG. 2 includes a usage component 202, a query component 204, and a sensed characteristics component 206. The usage component 202 is configured to obtain feedback 114 by monitoring the user's 106 use of, or interaction with, the UX 104. For example, the usage component 202 can monitor inputs (e.g., menu selections, keyboard shortcuts, etc.), or steps (e.g., a set of features, etc.), employed by the user 106 to produce a result or output.

The query component 204 is configured to obtain explicit feedback 114 from the user 106 via one or more feedback queries or questions. The query component 204 can generate one or more feedback queries, and provide the feedback queries to the user 106. The queries can relate to, for example, the user's comfort with a feature or function of the UX 104, emotional response to an event in the UX 104, or a desired result based on a set of inputs, etc. For instance, the query component 204 can provide a question to the user 106 regarding the desired result of a sequence of inputs in a computer aided drawing application, such as, “Were you trying to explode the drawing?” The query component 204 can receive a response to the feedback query (e.g., feedback 114) from the user 106. The response can include a selection from a set of options (e.g., yes, no, etc.), a rating (e.g., 1 to 10, etc.), a textual phrase, and so forth.

The sensed characteristics component 206 is configured to obtain, acquire, or otherwise receive a set of sensed characteristics of the user 106. The set of sensed characteristics can include virtually any characteristic of the user 106, including but not limited to heart rate, perspiration, body temperature, voice or audio data (e.g., tone, inflection, etc.), facial images, and so forth. The sensed characteristics component 206 can determine the sensed characteristics based on data (e.g., feedback 114) generated via a set of sensors 208. As discussed, the UX 104 can be executed via a computing device, and the set of sensors 208 can be included in the computing device, or can be stand-alone sensors. The set of sensors 208 can include a camera, a microphone, a heart rate monitor (e.g., pulse monitor), a temperature sensor (e.g., thermometer, etc.), touch screen, and so forth. For example, the sensed characteristics component 206 can determine that a heart rate of the user 106 is increasing via a heart-rate monitor associated with a smart phone.

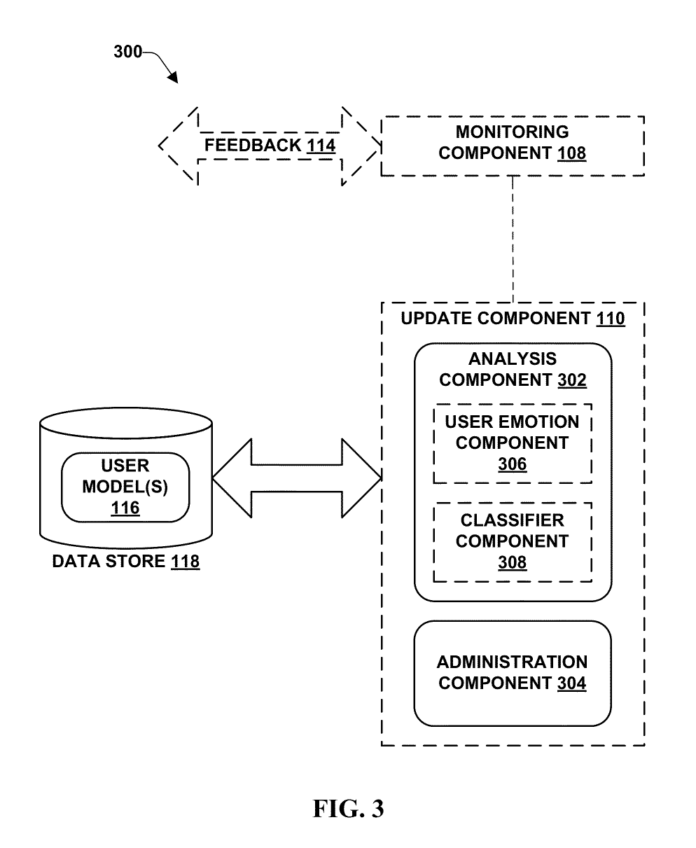

FIG. 3 illustrates an example update component 110 in accordance with various aspects described herein. As discussed, the update component 110 is configured to analyze the feedback 114, and adjust the user model 116 based on the analysis. The update component 110 in FIG. 3 includes an analysis component 302, and an administration component 304. The analysis component 302 is configured to interpret, translate, or otherwise analyze the feedback 114 to determine one or more attributes included in the user model 116. For example, the analysis component 302 can determine a skill level of the user 106 regarding a first feature (e.g., attribute) of the UX 104 based on feedback 114. The analysis component 302 can include a user emotion component 306, and a classifier component 308.

The user emotion component 306 is configured to determine an emotional state of the user 106 while interacting with the UX 104. The determined emotional state can be employed in determining one or more attributes in the user model 116 associated with the user 106. For instance, if the user 106 becomes frustrated while attempting to execute a function via the UX 104, then the analysis component 302 can determine that the user 106 lacks ability with regard to executing the function. The user emotion component 306 can determine the emotional state of the user 106 based in part on data generated by the set of sensors 208. For example, the user emotion component 306 can determine that the user 106 is frustrated based on audio data (e.g., speech or sounds) captured via a microphone (e.g., sensors 208) associated with a device executing the UX 104 (e.g., via the sensed characteristics component 206). As an additional example, the user emotion component 306 can determine that the user 106 is happy or pleased based on image data obtained from a camera (e.g., sensors 208) associated with the device. Furthermore, the user emotion component 306 can determine the emotional state of the user 106 based on feedback 114 generated in response to a query. For example, the user emotion component 306 can determine the emotional state of the user 106 based on language or other inputs provided in response to a query that indicate the user's 106 emotional state.

In addition, the user emotion component 306 can determine an emotional state of the user 106 based on a comparison with a set of emotional state data relating to other users. For instance, the user emotion component 306 can determine a set of reference points in an image of the user 106, and compare the reference points to reference points in images of other users to determine, for example, that the user 106 is frowning, smiling, squinting, etc. Additionally or alternatively, the user emotion component 306 can be trained to identify the user's 106 emotional state based on a set of training data associated with previous emotional states of the user 106. For example, the training data can include prior data generated by the set of sensors 208 (e.g., images, voice capture, heart rate, etc.), correlated with prior explicit feedback 114 regarding an emotional state of the user 106.

The classifier component 308 determines or infers one or more attributes for the user model 116 based in part on the feedback 114. For example, the classifier component 308 can facilitate the user emotion component 306 in determining an emotional state of the user 106. The classifier component 308 can employ, for example, a naïve Bayes classifier, a Hidden Markov Model (HMM), a support vector machine (SVM), a Bayesian network, a decision tree, a neural network, a fuzzy logic model, a probabilistic classifier, and so forth. The classifier is trained using a set of training data. For example, the set of training data can include attributes of disparate users producing similar feedback or attempting to execute similar functions via the UX 104.

The administration component 304 is configured to update, adjust, or otherwise modify the user model 116 associated with the user 106 based on the analysis of the feedback 114. For example, if it is determined that the user's 106 ability is above average with respect to a first portion of the UX 104, then the administration component 304 can update the attribute corresponding to an ability level for the first portion of the UX 104 in the user model 116 with a ranking, grade, score, etc. to indicate the user's ability (e.g., above average). Additionally or alternatively, the administration component 304 can update the user model 116 by incrementing or decrementing one or more values or scores for attributes in the user model 116. Furthermore, if a user model 116 is not associated with the user 106, then the administration component 304 can associate a user model 116 with the user 106, such as, a standard or default user model 116 for the UX 104.

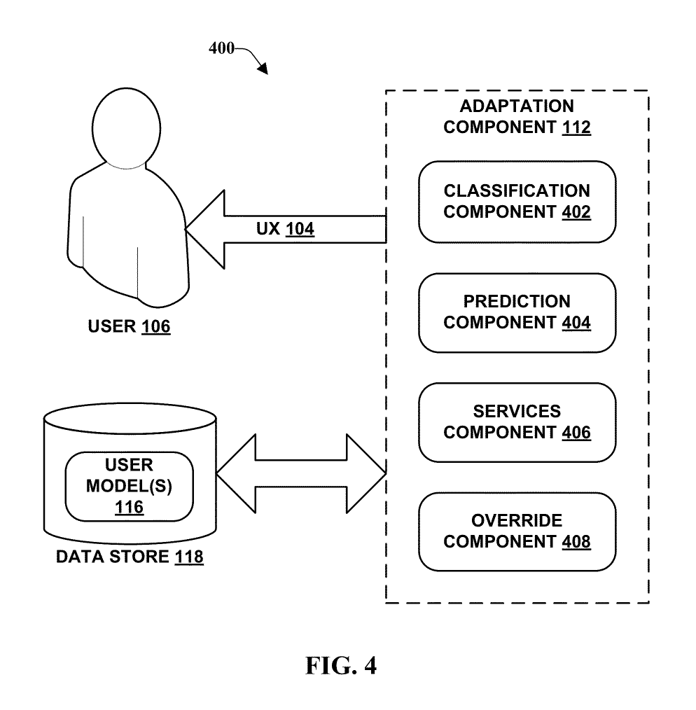

Referring to FIG. 4, illustrated is an example adaptation component 112 in accordance with various aspects described herein. As discussed, the adaptation component 112 is configured to modify the UX 104 based in part on a user model 116 associated with a user 106. The adaptation component 112 in FIG. 4 includes a classification component 402, a prediction component 404, a services component 406, and an override component 408. The classification component 402 is configured to classify the user 106 based in part on the user model 116 associated with the user 106. For example, the user 106 can be classified as a novice, intermediate, or expert user based on the user model 116, and the adaptation component 112 can modify the UX 104 based on the classification. It is to be appreciated that the classification component 402 can employ a virtually infinite quantity of classifications in classifying the user 106. In addition, the classification component 402 can classify one or more attributes included in the user model 116. For instance, an attribute score (e.g., grade, rank, etc.) for a first feature of the UX 104 can satisfy a set of criteria (e.g., exceed a threshold, etc.) for the user to be classified as an expert for the first feature, while the user 106 may be classified as a novice, etc. for a second feature. The adaptation component 112 can modify one or more features, functions, or operations of the UX 104 based on the classification. For example, the adaptation component 112 can modify a user interface associated with the UX based on the classification.

The prediction component 404 is configured to infer, determine, or otherwise predict one or more actions intended by the user 106, difficulties of the user 106, or errors of the user 106, with regards to UX 104 based at least in part on the user model 116, a classification, and/or emotional state of the user 106. For example, if the user 106 is classified a novice, then the prediction component 404 can determine that the user 106 is likely to have difficulty with a level of a video game included in the UX 104. As an additional example, by comparing the user model 116 associated with the user 106 to user models associated with other users, the prediction component 404 can determine that the user 106 is likely to make a set of errors when using an application included in the UX 104.

As yet another example, by leveraging actions taken by other users, the prediction component 404 can predict a function or action intended by the user 106. For instance, the user 106 may execute a help search for a question regarding usage of a feature associated with the UX 104; however, if the user 106 is inexperienced with the UX 104 (e.g., a novice), then the user 106 may be unaware of questions, keywords, phrases, etc. that will produce a desired answer. The prediction component 404 can determine an intent of the user's 106 question based in part on previous questions asked by more experienced (e.g., intermediate, expert, etc.) users. As still another example, if a current emotional state of the user is frustrated, then the prediction component 404 can determine a feature of the UX 104 that is frustrating the user 106, and an error that similar users (e.g., users having similar classifications or similar user models) are likely to make regarding the feature.

The services component 406 is configured to generate, enable, or otherwise provide one or more services to the user 106 based in part on the user model 116, a classification, an emotional state of the user 106, and/or a prediction. The services can include, but are not limited to modification of the UX 104, providing a set of advertisements, providing suggestions or tutorials, enabling access to a marketplace, or providing remote assistance. For example, if the UX 104 includes a video game, and the user 106 is classified as a novice regarding a first function of the video game (e.g., jumping, shooting, etc.), then the services component 406 can modify the video game, or game play, to assist the user 106 with the first function. As additional examples, the services component 406 can provide the user 106 with a tutorial regarding the first function, provide a set of advertisements for aids to assist the user 106, provide access to a marketplace that contains aids, tutorials, additional gaming features, etc., or enable another user to assist the user with the function via remote assistance.

The override component 408 is configured to enable the user 106 to remove, supersede, or otherwise override one or more services. For example, if the services component 406 removes a set of menus from a user interface associated with the UX 104 based on the user model 116 indicating the user 106 predominately employs keyboard shortcuts, then the override component 408 can enable the user 106 to reinstate the set of menus. In addition, the override component 408 can periodically remove services provided by the services component 406 to ensure that the user 106 desires the services. For example, the override component 408 can temporarily reinstate a set of menus that were previously removed by the services component 406. If the user 106 uses the set of menus during the period of reinstatement, then the override component 408 can override the service, and reinstate the set of menus. If the user does not use the set of menus, or removes (e.g., hides) the set of menus, then the service can remain.

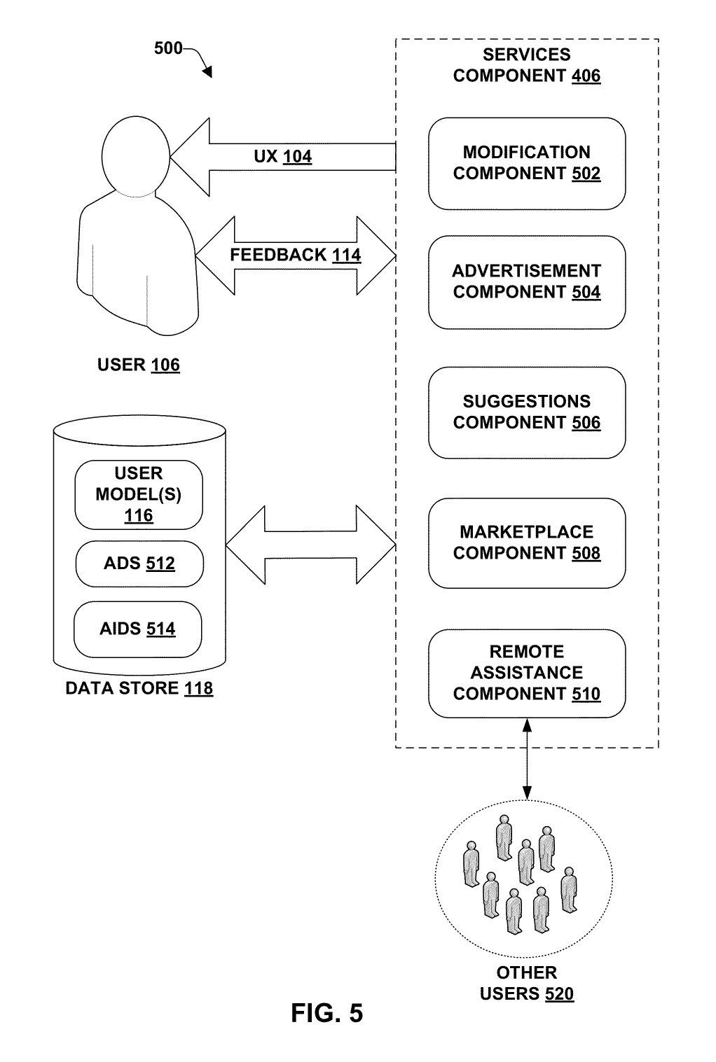

FIG. 5 illustrates an example services component 406 in accordance with various aspects described herein. As discussed, the services component 406 is configured to provide one or more services to the user 106 based in part on the user model 116, a classification, an emotional state of the user 106, and/or a prediction. The services component 406 in FIG. 5 includes a modification component 502, an advertisement component 504, a suggestions component 506, a marketplace component 508, and a remote assistance component 510. The modification component 502 is configured to adjust, update, or otherwise modify one or more aspects of the UX 104 based in part on the user model 116, a classification, an emotional state, and/or a prediction. The modification component 502 can modify virtually any aspect of the UX 104, including but not limited to a user interface, a function, a feature, a difficulty, a display, an operation, etc. For example, where the UX 104 includes an application, the modification component 502 can adjust a user interface associated with the application based on a classification (e.g., novice, intermediate, expert, etc.) of the user 106.

The advertisement component 504 is configured to generate, display, or otherwise provide one or more advertisements (ads) 512 based in part on the user model 116, a classification, an emotional state of the user 106, and/or a prediction. For example, if the user model 116 indicates the user 106 is a technology savvy user (e.g., engineer, programmer, etc.), then the advertisement can provide a set of advertisements for technology related tools associated with the UX 104 for the user 106. As an additional example, the advertisement component 504 can provide a set of advertisements for tutorials for the first feature based on a prediction that the user 106 will have difficulty with a first feature of the UX 104. It is to be appreciated that although the advertisements 512 are illustrated as being maintained in the data store 118, such implementation is not so limited. For instance, the advertisements 512 can be included in the advertisement component 504, or maintained in a disparate location and accessed via a network connection.

The suggestions component 506 is configured to generate, display, or otherwise provide one or more aids 514 based in part on the user model 116, a classification, an emotional state of the user 106, and/or a prediction. The aids 514 can include suggestions, tutorials, templates, macros, algorithms, and so forth. For example, the suggestions component 506 can provide an aid 514 to the user 106 that includes a tutorial on using the feature based on a predication that the user 106 is having difficulty using a feature of the UX 104. As an additional example, if the UX 104 includes a video game, and the user model 116 indicates the user 106 is likely to have difficulty with the current level, then the suggestions component 506 can provide a set of suggestions (e.g., aids 514) to assist the user 106 with the level. The aids 514 can be predetermined, or can be dynamically generated based on experiences of other users. For example, if users classified as experts often employ a first approach to complete a function, then the aids for the function can include suggestions regarding the first approach. In addition, the suggestions component 506 can update the aids 514 based on the experience of the user 106. For example, if a first tutorial is not helpful to the user 106, then the first tutorial may be updated, removed, or may not be provided to other users having similar user models 116 or classifications as the user 106.

The marketplace component 508 is configured to provide the user 106 access to a set services in a marketplace based in part on the user model 116, a classification, an emotional state of the user 106, and/or a prediction. The services can include virtually any object or feature associated with the UX 104. For example, if the UX 104 includes a computer aided drawing application, and the user 106 is attempting to draw, or search for, a widget via the application, then the marketplace component 508 can provide the user 106 access to a set of widgets in a marketplace associated with the application. As an additional example, if the UX 104 generates a result that the user 106 is having trouble interpreting, then the marketplace component 508 can provide access to a set of tools for interpreting the result (e.g., algorithms, filters, etc.), wherein the tools can be generated by a designer of the UX 104 or other users.

The remote assistance component 510 is configured to enable one or more other users 520 to provide remote assistance to the user 106 for the UX 104 based in part on the user model 116, a classification, an emotional state of the user 106, and/or a prediction. The other users 520 can provide remote assistance to the user 106 via a network connection, and can include users having a classification or associated user model 116 that satisfies one or more criteria to provide remote assistance. For example, the other users 520 can be classified as experts regarding the UX 104, or a feature of the UX 104. Additionally or alternatively, the other users 520 can include UX 104 support professionals. For example, the remote assistance component 510 can enable a support professional to provide assistance the user 106, if the user is becoming increasingly frustrated (e.g. deteriorating emotional state) despite other services (e.g., aids 514, etc.) being provided. It is to be appreciated that the remote assistance component 510 can be a stand-alone component, or can be included in or associated with the marketplace component 508. For example, the marketplace component 508 can provide access to the set of other users 520 for remote assistance, and the user 106 can purchase remote assistance from one or more other users 520.

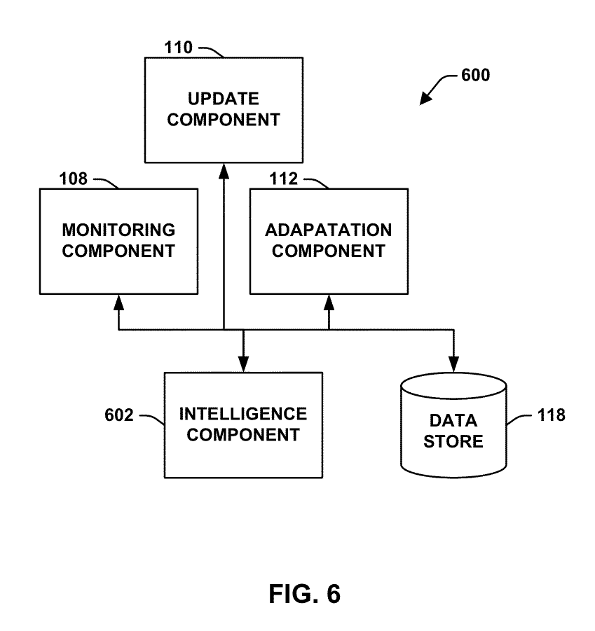

Referring now to FIG. 6, system 600 that can provide for or aid with various inferences or intelligent determinations is depicted. Generally, system 600 can include all or a portion of the monitoring component 108, the update component 110, and the adaptation component 112 as substantially described herein. In addition to what has been described, the above-mentioned components can make intelligent determinations or inferences. For example, monitoring component 108 can intelligently determine or infer a set of feedback 114 from the user 106.

Likewise, the update component 110 can also employ intelligent determinations or inferences in connection with analyzing feedback, and/or updating a user model 116. In addition, the adaptation component 112 can intelligently determine or infer a set services to provide to the user 106, and/or modifications of the UX 104. Any of the foregoing inferences can potentially be based upon, e.g., Bayesian probabilities or confidence measures or based upon machine learning techniques related to historical analysis, feedback, and/or other determinations or inferences.

In addition, system 600 can also include an intelligence component 602 that can provide for or aid in various inferences or determinations. In particular, in accordance with or in addition to what has been described supra with respect to intelligent determination or inferences provided by various components described herein. For example, all or portions of monitoring component 108, the update component 110, and the adaptation component 112 (as well as other components described herein) can be operatively coupled to intelligence component 602. Additionally or alternatively, all or portions of intelligence component 602 can be included in one or more components described herein. Moreover, intelligence component 602 will typically have access to all or portions of data sets described herein, such as in the data store 118.

Accordingly, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

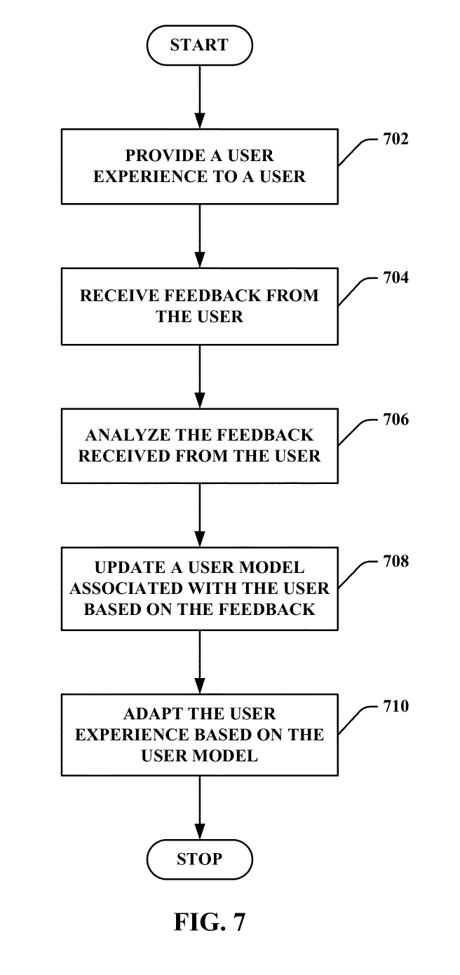

In view of the example systems described supra, methods that may be implemented in accordance with the disclosed subject matter may be better appreciated with reference to the flow charts of FIGS. 7-9. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Turning now to FIG. 7, illustrated is an example method 700 for dynamic user experience adaptation and service provisioning in accordance with various aspects described herein. Generally, at reference numeral 702, a user experience (UX) is provided to a user. The UX can include, but is not limited to, an operating system, an application (e.g., word processor, electronic mail, computer aided drafting, video game, etc.), a user interface, and so forth.

At reference numeral 704, feedback generated during, or in association with, the user's interaction with the UX is received. The feedback can be express or implied. For example, the feedback can include a response to a feedback question (e.g., challenge-answer feedback) provided to the user. As an additional example, the feedback can be implied based on the user's interaction (e.g., control, usage, inputs, etc.) with the UX, a sensed characteristic of the user (e.g., heart rate, temperature, stress, etc.) during interaction with the UX, or an emotional response (e.g., pleased, frustrated, etc.) to the UX or an event associated with the UX.

At reference numeral 706, the feedback is analyzed or interpreted. For example, if the feedback contains a quantity of instances of the user employing a set of keyboard shortcuts to achieve an output or result above a predetermined threshold, then the feedback can be interpreted as indicating that the user is familiar with the menu options for the application. At reference numeral 708, a user model associated with the user can be updated based on the analysis or interpretation of the feedback. The user model can include a set of attributes corresponding to features of the UX. Returning to the previous example, when the feedback is interpreted as indicating the user is familiar with the menu options for the application, a subset of attributes in the user model associated with the user can be updated to reflect the user's familiarity with the menu options for the application. The user model can be updated by assigning a grade, score, classification, etc. to one or more of the attributes. Additionally or alternatively, the user model can be updated by incrementing or decrementing a value or score for one or more attributes.

At reference numeral 710, the UX is adapted based on the user model. Adapting the UX can include adding (e.g., displaying, exposing, etc.) or removing (e.g., hiding, suppressing, etc.) features or functions. Virtually any aspect of the UX can be adapted based on the user model, including, but not limited to, a user interface, a function, a feature, a difficulty, a display, an operation, etc. For example, where the UX includes an application, a user interface associated with the UX can be adjusted to provide features commensurate with a skill level of the user (e.g., novice, intermediate, expert, etc.).

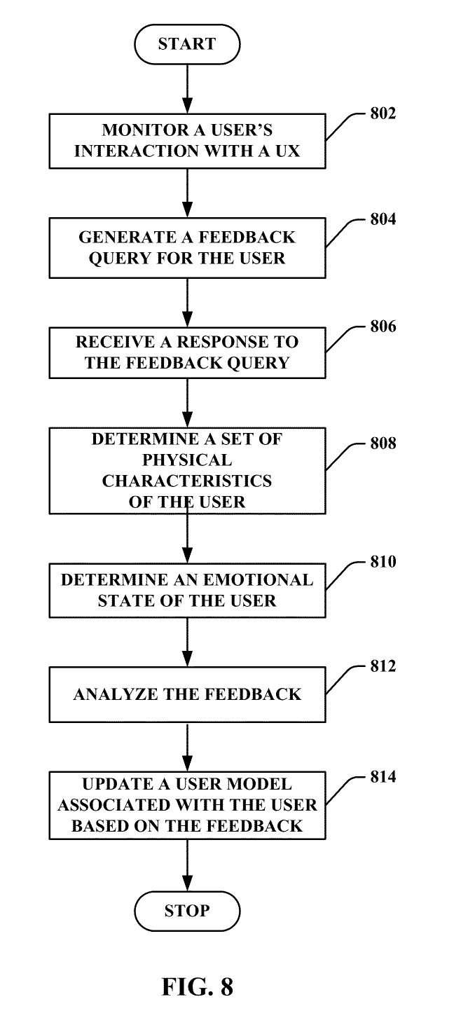

FIG. 8 illustrates an example method 800 for dynamic user experience adaptation and service provisioning in accordance with various aspects described herein. Generally, at reference numeral 802, a user's interaction with a user experience (UX) is monitored to obtain usage feedback. For example, inputs (e.g., menu selections, keyboard shortcuts, etc.), or steps (e.g., a set of features, etc.), employed by the user to produce a result can be monitored. At reference numeral 804, a feedback query can be generated and provided to the user. The query can relate to, for example, the user's comfort with a feature or function of the UX, emotional response to an event in the UX, desired result or output based on a set of inputs, and so forth, and can be based in part on the usage feedback. For instance, a question can be provided to the user regarding the desired result of a sequence of inputs in a computer aided drawing application, such as, “Were you trying to explode the drawing?” At reference numeral 806, a response to the feedback query can be received from the user (e.g. query feedback). The response can include a selection from a set of options (e.g., yes, no, etc.), a rating (e.g., 1 to 10, etc.), a textual phrase, and so forth.

At reference numeral 808, a set of sensed characteristics of the user can be determined. The set of sensed characteristics can include virtually any characteristic of the user, including, but not limited to, heart rate, perspiration, body temperature, voice or audio data (e.g., tone, inflection, etc.), facial images, and so forth. The sensed characteristics can be determined based on data from a set of sensors. The set of sensors can be included in a computing device employed by the user, or can be stand-alone sensors. The set of sensors can include a camera, a microphone, a heart rate monitor (e.g., pulse monitor), a temperature sensor (e.g., thermometer, etc.), a perspiration sensor, and so forth. For example, it can be determined that the user's heart rate is increasing via a heart-rate monitor associated with the user's smart phone, where the smart phone is executing the UX.

At reference numeral 810, an emotional state of the user can be determined based on the sensed characteristics, query feedback, and/or usage feedback. The user's emotional state can be determined based on comparisons with a set of emotional state data relating to other users. For example, the user's emotional state can be determined by compare an image of the user to images of other users. Additionally or alternatively, the user's emotional state can be determined based on a set of training data associated with previous emotional states of the user. For example, the training data can include previous sensed characteristics for the user that are correlated with prior usage feedback and/or query feedback to determine emotional states of the user.

At reference numeral 812, the usage feedback, query feedback, and/or sensed characteristics are analyzed to determine one or more attributes for a user model associated with the user. For example, a skill level of the user regarding a first feature (e.g., attribute) of the UX can be determined based on the feedback. At reference numeral 814, the user model associated with the user can be updated based on the analysis of the feedback. As discussed, the user model can include a set of attributes corresponding to features of the UX. The user model can be updated by assigning a grade, score, classification, etc. to one or more of the attributes. Additionally or alternatively, the user model can be updated by incrementing or decrementing a value or score for one or more attributes.

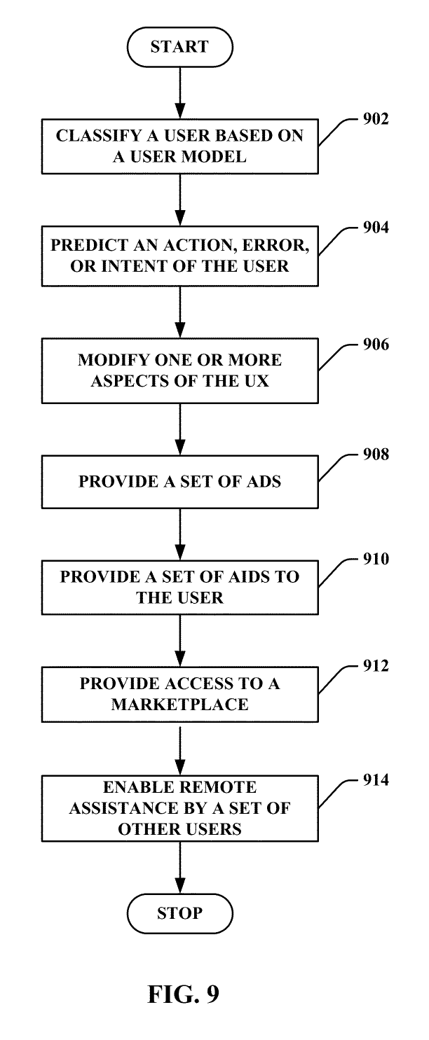

Turning now to FIG. 9, illustrated is an example method 900 for dynamic user experience adaptation and service provisioning in accordance with various aspects described herein. Generally, at reference numeral 902 a user can be classified based in part on a user model. As discussed, the user model can include a set of attributes corresponding to features of the user experience (UX), can be updated based on feedback for the user regarding determined sensed characteristics, feedback responses, usage feedback, and/or determined emotional states. For example, the user can be classified as a novice, intermediate, or expert for the UX user based on the user model. Additionally or alternatively, one or more attributes of the user can be classified based on corresponding attributes included in the user model. For instance, an attribute score (e.g., grade, rank, etc.) for a first feature of the UX can satisfy a set of criteria (e.g., a threshold, etc.) for the user to be classified as an expert for the first feature, and the user can be classified as a novice for a second feature.

At reference numeral 904, one or more actions intended by the user, difficulties (e.g., that the user is having or likely to have), or errors (e.g., that the user is making or likely to make) can be predicted based at least in part on the user model, an emotional state, a prediction, and/or a classification. For example, it can be predicted that the user is likely to have difficulty with a level of a video game based on the user being classified as a novice. As an additional example, it can be predicted that the user is likely to make a set of errors when using an application, by comparing the user model associated with the user to user models associated with other users.

At reference numeral 906, one or more aspects of the UX can be modified based in part on the user model, a classification, an emotional state, and/or a prediction. Virtually any aspect of the UX can be modified, including but not limited to a user interface, a function, a feature, a difficulty, a display, operation, etc. For example, where the UX includes an application, a user interface associated with the application can be adjusted based on a classification of the user (e.g., novice, intermediate, expert, etc.).

At reference numeral 908, a set of advertisements (ads) can be provided based in part on the user model, a classification, feedback, and/or a prediction. For example, if the user model indicates the user is employed in a first field, then a set of advertisements for tools related to the first field associated with the UX can be provided.

At reference numeral 910, a set of aids can be provided based in part on the user model, a classification, an emotional state, and/or a prediction. As discussed, the aids can include suggestions, tutorials, templates, macros, algorithms, and so forth. For example, a tutorial regarding a feature can be provided based on a predication that the user is having, or will have, difficulty using a feature of the UX. As an additional example, if the UX includes a video game, and the user model associated with the user indicates that the user is likely to have difficulty a the current level, then a set of suggestions can be provided to assist the user with the level.

At reference numeral 912, access to a set of goods or services in a marketplace can be provided based in part on the user model, a classification, feedback, an emotional state, and/or a prediction. The goods can include virtually any good (e.g., object, feature, etc.) or service associated with the UX. For example, if the UX includes a computer aided drawing application, and the user is attempting to draw, or searching for, a widget via the application, then access to a set of widgets in a marketplace associated with the application can be provided.

At reference numeral 914, one or more other users are enabled to provide remote assistance to the user for the UX based in part on the user model, a classification, an emotional state, and/or a prediction. The other users can provide remote assistance to the user via a network connection, and can include users having a classification or associated user model that satisfies one or more criteria to provide remote assistance. For example, the other users can be classified as experts regarding the UX, or a feature of the UX. Additionally or alternatively, remote assistance can be provided by support professionals.

### Exemplary Networked and Distributed Environments

One of ordinary skill in the art can appreciate that the various embodiments for dynamic code generation and memory management for COM objects described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the mechanisms for dynamic code generation and memory management for COM objects as described for various embodiments of the subject disclosure.

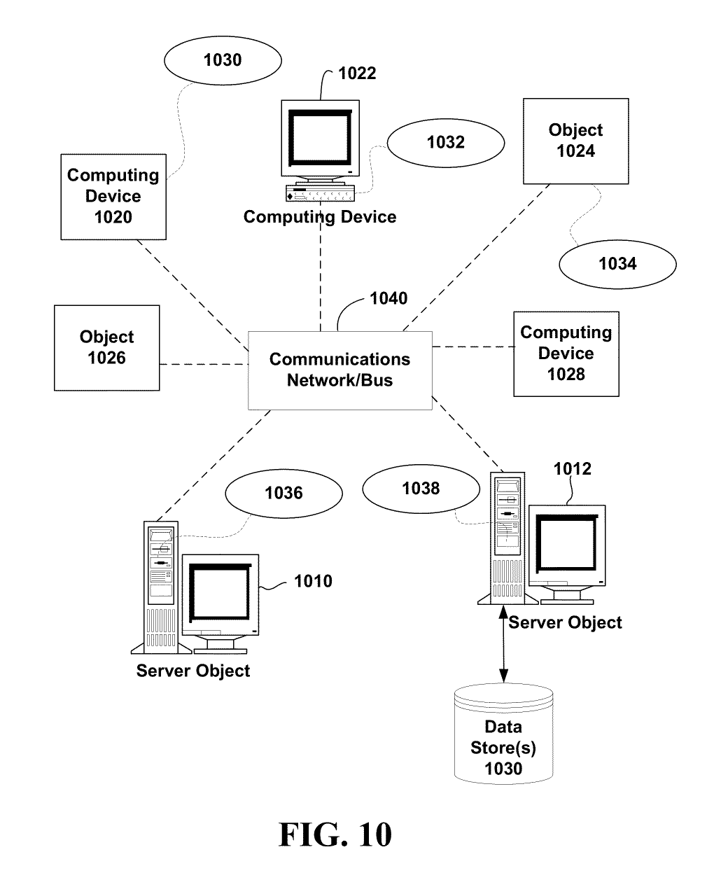

FIG. 10 provides a schematic diagram of an exemplary networked or distributed computing environment. The distributed computing environment comprises computing objects 1010, 1012, etc. and computing objects or devices 1020, 1022, 1024, 1026, 1028, etc., which may include programs, methods, data stores, programmable logic, etc., as represented by applications 1030, 1032, 1034, 1036, 1038 and data store(s) 1040. It can be appreciated that computing objects 1010, 1012, etc. and computing objects or devices 1020, 1022, 1024, 1026, 1028, etc. may comprise different devices, such as personal digital assistants (PDAs), audio/video devices, mobile phones, MP3 players, personal computers, laptops, etc.

Each computing object 1010, 1012, etc. and computing objects or devices 1020, 1022, 1024, 1026, 1028, etc. can communicate with one or more other computing objects 1010, 1012, etc. and computing objects or devices 1020, 1022, 1024, 1026, 1028, etc. by way of the communications network 1042, either directly or indirectly. Even though illustrated as a single element in FIG. 10, communications network 1042 may comprise other computing objects and computing devices that provide services to the system of FIG. 10, and/or may represent multiple interconnected networks, which are not shown. Each computing object 1010, 1012, etc. or computing object or devices 1020, 1022, 1024, 1026, 1028, etc. can also contain an application, such as applications 1030, 1032, 1034, 1036, 1038, that might make use of an API, or other object, software, firmware and/or hardware, suitable for communication with or implementation of the techniques for dynamic code generation and memory management for COM objects provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems for dynamic code generation and memory management for COM objects as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 10, as a non-limiting example, computing objects or devices 1020, 1022, 1024, 1026, 1028, etc. can be thought of as clients and computing objects 1010, 1012, etc. can be thought of as servers where computing objects 1010, 1012, etc., acting as servers provide data services, such as receiving data from client computing objects or devices 1020, 1022, 1024, 1026, 1028, etc., storing of data, processing of data, transmitting data to client computing objects or devices 1020, 1022, 1024, 1026, 1028, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1042 or bus is the Internet, for example, the computing objects 1010, 1012, etc. can be Web servers with which other computing objects or devices 1020, 1022, 1024, 1026, 1028, etc. communicate via any of a number of known protocols, such as the hypertext transfer protocol (HTTP). Computing objects 1010, 1012, etc. acting as servers may also serve as clients, e.g., computing objects or devices 1020, 1022, 1024, 1026, 1028, etc., as may be characteristic of a distributed computing environment.

### Exemplary Computing Device

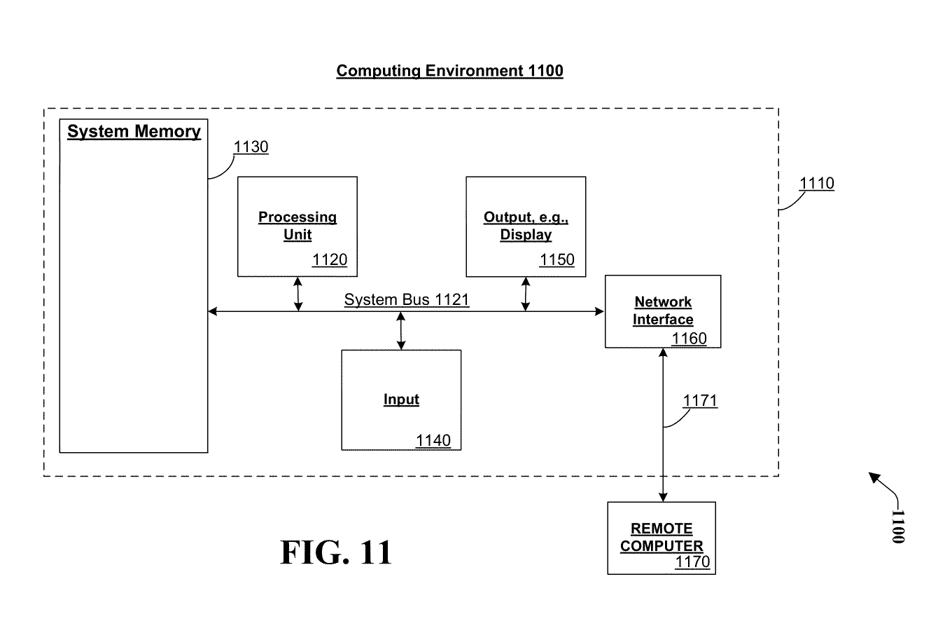

As mentioned, advantageously, the techniques described herein can be applied to any device where it is desirable to perform dynamic code generation and memory management for COM objects in a computing system. It can be understood, therefore, that handheld, portable and other computing devices and computing objects of all kinds are contemplated for use in connection with the various embodiments, i.e., anywhere that resource usage of a device may be desirably optimized. Accordingly, the below general purpose remote computer described below in FIG. 11 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 11 thus illustrates an example of a suitable computing system environment 1100 in which one or aspects of the embodiments described herein can be implemented, although as made clear above, the computing system environment 1100 is only one example of a suitable computing environment and is not intended to suggest any limitation as to scope of use or functionality. Neither should the computing system environment 1100 be interpreted as having any dependency or requirement relating to any one or combination of components illustrated in the exemplary computing system environment 1100.

With reference to FIG. 11, an exemplary remote device for implementing one or more embodiments includes a general purpose computing device in the form of a computer 1110. Components of computer 1110 may include, but are not limited to, a processing unit 1120, a system memory 1130, and a system bus 1122 that couples various system components including the system memory to the processing unit 1120.

Computer 1110 typically includes a variety of computer readable media and can be any available media that can be accessed by computer 1110. The system memory 1130 may include computer storage media in the form of volatile and/or nonvolatile memory such as read only memory (ROM) and/or random access memory (RAM). By way of example, and not limitation, system memory 1130 may also include an operating system, application programs, other program modules, and program data. According to a further example, computer 1110 can also include a variety of other media (not shown), which can include, without limitation, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information.

A user can enter commands and information into the computer 1110 through input devices 1140. A monitor or other type of display device is also connected to the system bus 1122 via an interface, such as output interface 1150. In addition to a monitor, computers can also include other peripheral output devices such as speakers and a printer, which may be connected through output interface 1150.

The computer 1110 may operate in a networked or distributed environment using logical connections, such as network interfaces 1160, to one or more other remote computers, such as remote computer 1170. The remote computer 1170 may be a personal computer, a server, a router, a network PC, a peer device or other common network node, or any other remote media consumption or transmission device, and may include any or all of the elements described above relative to the computer 1110. The logical connections depicted in FIG. 11 include a network 1172, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system.

In addition, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A computing device, comprising:
a memory having computer executable components stored thereon; and
a processor communicatively coupled to the memory, the processor configured to facilitate execution of one or more of the computer executable components, the computer executable components, comprising:
a monitoring component configured to receive feedback generated in association with interaction with a user experience by a user;
an update component configured to analyze the feedback, and update a user model associated with the user based at least in part on the analysis; and
an adaptation component configured to modify the user experience based at least in part the user model.

2. The computing device of claim 1, wherein the feedback includes at least one of: usage feedback, query feedback, or a sensed characteristic of the user.

3. The computing device of claim 2, wherein the sensed characteristic of the user is obtained via a set of sensors associated with a user device.

4. The computing device of claim 1, wherein the update component is further configured to determine an emotional state of the user based at least in part on the analysis.

5. The computing device of claim 1, wherein the adaptation component is further configured to provide a set of services to the user.

6. The computing device of claim 5, further comprising a prediction component configured to predict at least one of: an action intended by the user, a difficulty of the user, or an error of the user, wherein the adaptation component is further configured to provide the set of services based at least in part on the prediction.

7. The computing device of claim 5, further comprising a classification component configured to classify the user based at least in part on the user model, wherein the adaptation component is further configured to provide the set of services based at least in part on the classification.

8. The computing device of claim 5, wherein the set of services includes at least one of an advertisement, an aid, a marketplace, or remote assistance.

9. A method, comprising:
receiving feedback generated during interaction with a user experience by a user;
interpreting the feedback based at least in part on a set of attributes included in a user model for the user experience;
updating at least one of the attributes in the set of attributes in a user model associated with the user based at least in part on the interpretation; and
adapting the user experience for the user based at least in part the user model.

10. The method of claim 9, wherein the receiving the feedback includes receiving at least one of: usage feedback, query feedback, or a sensed characteristic of the user.

11. The method of claim 9, wherein the receiving the sensed characteristic of the user includes receiving the sensed characteristic of the user from a set of sensors associated with a user device.

12. The method of claim 9, wherein the interpreting the feedback includes determining an emotional state of the user.

13. The method of claim 9, wherein the adapting the user experience for the user includes providing a set of services to the user.

14. The method of claim 13, further comprising predicting at least one of: an action intended by the user, a difficulty of the user, or an error, wherein the providing the set services is based at least in part on the prediction.

15. The method of claim 13, further comprising classifying the user based at least in part on the user model, wherein the providing the set services is based at least in part on the classification.

16. The method of claim 13, wherein the providing the set services includes providing at least one of: an advertisement, an aid, a marketplace, or remote assistance.

17. A computer-readable storage device comprising computer-readable instructions that, in response to execution, cause a computing system to perform operations, comprising:
monitoring interaction with a user experience by a user;
obtaining feedback associated with the interaction including at least one of: usage feedback, query feedback, or a sensed characteristic of the user;
updating a user model associated with the user based at least in part on the feedback; and
adapting the user experience for the user, based at least in part on the user model, including at least one of: modifying at least one feature of the user experience, or providing at least one of: an advertisement, an aid, a marketplace, or remote assistance.

18. The computer-readable storage device of claim 17, further comprising determining an emotional state of the user based at least in part on the feedback, wherein the adapting the user experience for the user is based at least in part on the emotional state.

19. The computer-readable storage device of claim 17, further comprising classifying the user based at least in part on the user model, wherein the adapting the user experience for the user is based at least in part on the classification.

20. The computer-readable storage device of claim 17, wherein the updating the user model associated with the user based at least in part on the feedback includes updating at least one attribute included in the user model based at least in part on the feedback.
